(19) United States
(12) Patent Application Publication
(10) Pub. No.: US 2007/0178186 A1
(43) Pub. Date: Aug. 2, 2007

(54) High-Stress Seals for Injection Molding Machines

(75) Inventor: Michael Goinski, Rodgau (DE)

Correspondence Address: Thomas Moga;Butzel Long, STONERIDGE WEST, 41000 WOODWARD AVENUE, BLOOMFIELD HILLS, MI, 48304, US

(73) Assignee: INCOE CORPORATION, Troy, MI (US)

(21) Appl. No.: 11/668,584

(22) Filed: Jan. 30, 2007

(30) Foreign Application Priority Data
Jan. 31, 2006 (DE) 10 2006 004 265.4
Sep. 8, 2006 (US) PCT/US06/35077

(51) Int. Cl. B29C 45/20

(52) U.S. Cl. 425/569; 425/DIG. 47

(57) ABSTRACT

A high-stress seal for injection molding machines, intended for sealing the gap between the injector nozzle and the injector rail of the tool. The seal in the ingate area is designed in a dome shape with an opening in the top of the dome for flux to enter. Correspondingly, the injector nozzles and the opposing wall of the injector rail of the tool have a dome-shaped design and are spatially adapted to the seal. This construction provides the seal with very dense, firm placement when the injector is pressed into the tool recess, and flux under high pressure cannot dislodge it.

### BACKGROUND OF THE INVENTION

The present invention relates generally to high-stress seals for injection molding melt delivery systems.

During injection, plastic resin is forced from an injection machine, directly or through a manifold, into a nozzle, and from this into a mold cavity. Injection machines, manifolds, nozzles and molds are separate parts, and at the melt channel transition points from one part to another, an outside seal must be provided. Great demands are placed on these seals, because, due to its high temperatures, the plastic resin flowing through the melt channels has a low viscosity comparable to water, and the molten material is under high pressure.

Between the injection machine and the manifold, as between the manifold and nozzle, gasket seals in the form of O-rings are generally used, which are placed in a groove in one of the two coplanar surfaces. They secure the gap between the two coplanar contact surfaces; however, under very high pressure, the plastic resin tends to force itself into the space between the seal and the contact sealing surfaces and to ooze out.

Under current technology, the seal necessary between the nozzle tip and the tool takes the form of a precision cylinder-ring seal. Hereinafter, this seal will be referred to as an annular gap seal. In the so-called precision seal, the nozzle in the area of the gate is equipped with a round-cylinder outer surface that, with a high-precision fit, goes into a corresponding hollow-cylinder surface in the recess in the tool. The two metal cylinder ring surfaces create the seal through direct placement, without the use of a sealing material on the outside. When a seal is placed in a gap between two such cylindrical surfaces, the seal will be pushed out by the high pressure of the plastic resin. Due to the production accuracy necessary, the manufacture of such a precision seal is expensive, and it is very susceptible to wear and damage.

The aforementioned seals can be used only at plastic resin operating pressures up to approximately 200 bar.

### SUMMARY OF THE INVENTION

The invention is based on the need to develop high-stress seals for injection molding melt delivery systems, which can endure higher pressure levels than current state-of-the-art seals, and whose cost to manufacture is less expensive.

The invention involves two types of seals. The gaskets, as is typical for O-rings, can be inserted into a groove. Their distinctive feature is that their sealing pressure is strengthened by the pressure of the flux intruding into the groove.

The distinctive feature of the new annular gap seal is that it has a form highly adapted to the contact surfaces to be sealed near the gate area between the injector nozzles and the tool, and that it is pressed into the space between these surfaces. In this way, the seal is adapted to the given spatial relationships, thus small shape irregularities or scorings can be compensated for by the seal. To achieve secure seating of the seal, the seal, and the nozzle and tool surfaces specified for the mold, are given a shape such that it is practically impossible for the plastic resin pressure to push our or bulge the seal.

In this invention, the high-stress seals are manufactured from a high-temperature-resistant sealant material, consisting for example of plastic, such as PTFE or VESPEL. With this invention, injection molding machines using this seal can be operated up to 2500 bar.

To achieve this task, high-stress seals for injection molding machines are provided in a first preferred embodiment and comprise a high-stress seal for an injection molding melt delivery system including a nozzle with nozzle cap connected to a manifold through which plastic resin flows through a flow channel and a tool having an injection side portion about the nozzle and nozzle cap and an ejection side portion, the seal comprising an outer and inner surface area, wherein the inner surface area is shaped according to the outer surface area of the nozzle tip of the nozzle and the outer surface area is shaped according to the inner surface area of the injection side portion of the tool; and an opening in the seal extending between the outer and inner surface areas allowing plastic resin to flow through the nozzle from the injection side portion of the tool to the ejection side portion of the tool, wherein the seal is formed to fit within a space between the nozzle tip and the injection side portion of the tool, and in which the nozzle tip and the opposing wall of the injection side portion of the tool are spatially adapted to the similarly designed seal; wherein the seal has such a form that when placed within the space between the nozzle tip and the injection side portion of the tool, the contact pressure of the seal against the sealing surface is strengthened by the pressure of the molten plastic resin.

In a second preferred embodiment the high-stress seal for use in an injection molding melt delivery system comprises an annular gap seal for securing a gap between two coplanar surfaces that surround a flow channel for molten plastic resin, wherein the seal is formed of high-temperature sealant material having a profile such that the seal fits within a space between the two opposing parts to be sealed and the seal is strengthened and can withstand pressures of up to 2500 bar wherein the profiled seal cannot be measurably pushed out of place or moved from the gap when contact pressure of the molten plastic resin occurs against the sealing surface of the seal. The seal profile preferably comprises an annular ring having an inner diameter along the flow channel for the molten plastic resin and a groove extending about said inner diameter exposed to the flow channel, the groove having a triangular profile including tapered sides converging into a rounded bottom, and wherein the annular seal ring is seated within a groove in one of the two co-planar surfaces such that the height of the seated seal in an unstressed state is 10 percent greater than the depth of the co-planar surface groove.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 illustrates the transition points between a manifold and a nozzle with a gasket involved in a first preferred embodiment in accordance with the present invention;

FIG. 2 is a fragmentary enlarged detail view of FIG. 1 illustrating a seal of the preferred embodiment in accordance with the present invention;

FIG. 3 is a fragmentary enlarged detail interior view of the gate area of a nozzle of FIG. 1 that opens to the mold cavity illustrating an annular gap seal in accordance with the present invention located between the nozzle and the tool; and

FIG. 4 is a fragmentary enlarged detail interior view of FIG. 3 of a second preferred embodiment in accordance with the present invention illustrating a small, modified seal.

### DESCRIPTION OF THE PREFERRED EMBODIMENT

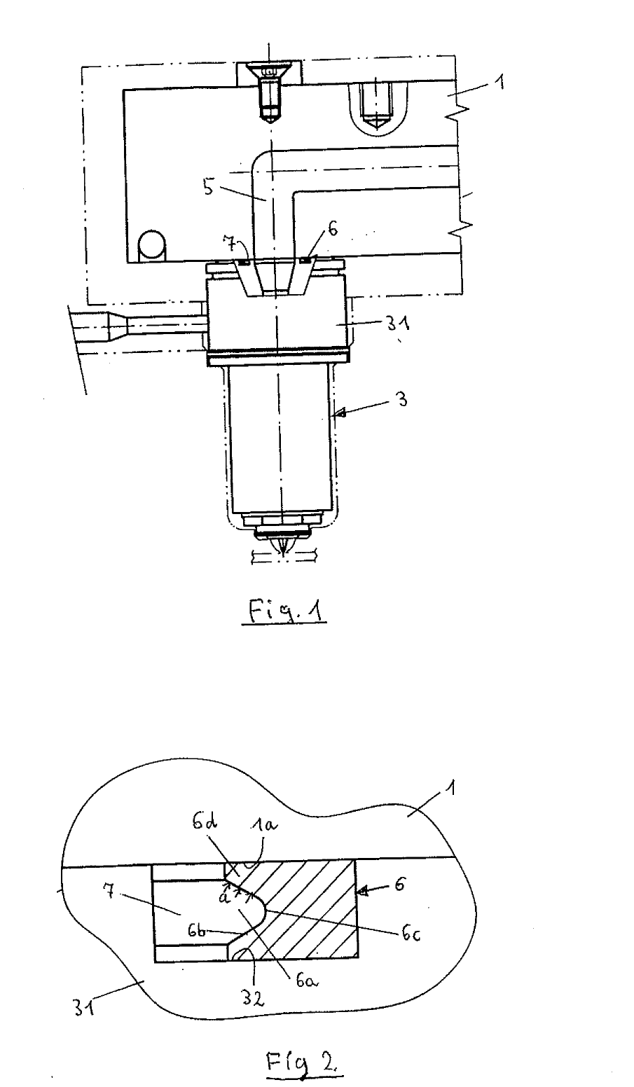

FIG. 1 shows the connection of a nozzle (3) to a partially depicted manifold (1) through whose flow channel (5) plastic resin is supplied by an injection machine.

Compression due to thermal expansion is pressing the nozzle (3) and the manifold (1) firmly against one another. A seal is necessary at the transition point between the manifold (1) and the nozzle (3) between two coplanar surfaces. The seal (6) lies in a radial groove (7) in the rear (upper) end face of the nozzle head (31). It is a high-stress seal according to the invention, whose construction can be seen more precisely in FIG. 2: The seal (6) has a radial groove (6a) on its side closest to the flow channel. In the implementation example shown, this groove has tapered sides (6b) and a rounded bottom (6c). Thus, its profile resembles a triangle in which the bottom (6c) that forms the peak is very rounded. If the highly pressurized plastic resin is forced into the free space of the groove (7), it presses onto the sides (6b) of the groove (6a), as indicated by the arrows (a), and thereby presses both lips (6d) of the seal with greater strength against the contact surfaces (1a) and (32), so that the penetration of plastic resin between the seal and the contact surfaces is further resisted.

The advantage is that the height of the seal (6) before its restraint between the nozzle (3) and the manifold (1) is greater than the depth of the groove (7) (e.g., about 10%), so that the seal is under prestress between the nozzle (3) and the manifold (1).

FIG. 3 shows an operational example of a high-stress annular gap seal (11) according to this invention, in the gate area of the nozzle (3) in connection with a corresponding formation of the nozzle (34) and that of the recess in the tool (21) for the nozzle. In this illustration, the tool (2) is shown for reference purposes only. The injection side portion of the tool is indicated by the number 22, the ejection side portion by 23, and the cavity by 24. A nozzle tip insert (34) is slid into the nozzle base (32) with the flow channel (33), and is held by a screwed-on nozzle cap (35). The number 36 indicates a heating element slid onto the nozzle, 37 indicates insulation, and 38 a guide ring.

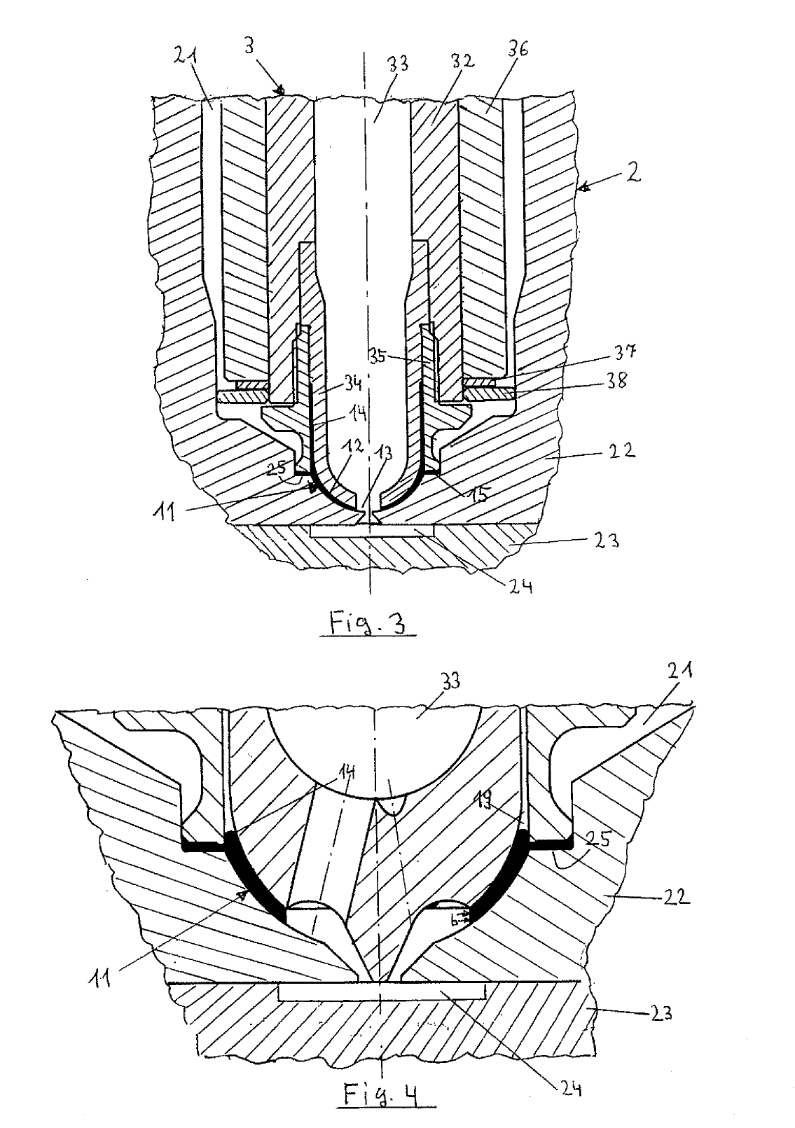

The high-stress seal (11) of the invention is depicted in black. In its forward portion (12), the seal (11) is shown as dome-shaped and occupies the center of the dome-shaped portion (13) of a central opening for plastic resin. Correspondingly, the nozzle tip (34) and the tool recess (21) in the injection side portion (22) are designed so that the dome-shaped part (12) of the seal, after successful insertion of the nozzle into the tool, fills in the gap (19) (FIG. 4) that lies between the injector nozzle tip (34) and the tool recess (21) in the injector side portion of the tool (22).

From the base of the dome-shaped part (12) of the seal, there extends an integral hollow-cylinder feature (14) into the gap (19) between the nozzle tip (34) and the nozzle cap (35). In addition, a flat ring-shaped sealing flange (15) extends from the dome-shaped portion (12) of the seal (11). The flange is located between the lower face of the nozzle cap (35) and the opposing surface (25) of the injection side portion (22) of the tool (2).

Due to the shape of the seal (11) and that of the gap created in between the nozzle tip (34), the nozzle cap (35), and the tool recess (21), the seal (11) has a very firm position, and can only be minimally be moved by pressure from the plastic resin. This is shown more clearly in FIG. 4, in which small arrows (b) indicate the contact surface for the plastic resin. The pressure exerted here is nearly incapable of pushing the seal from its place.

FIG. 4 is an expanded view of the relationships shown in FIG. 3. The seal (11) is designed for slight variation, so that it will not extend so deeply into the gap (19) between the nozzle tip (34) and the nozzle cap (35).

The effectiveness of the annular gap seal shown in FIGS. 3 and 4 can only be attained if the nozzle and the wall of the tool recess (21) that opposes it are designed with a form adapted to the seal (or vice versa).

Besides having a dome-shaped design, the annular gap seal (11), the nozzle (34) and the opposing wall of the tool recess (21) can be designed in alternative forms but not limited to a cone or some similar form.

Manufacture of the seals in this invention from the high-temperature material mentioned in the introduction varies for the gaskets (FIGS. 1 and 2) and the annular gap seals (FIGS. 3 and 4) between the injector nozzle and the tool: for example, the gaskets can be punched from rings of available flat material with the inside diameter of the ring being cut to the face of the ring groove (7).

The annular gap seals can then be manufactured by punching a ring or disk in which a central hole has been bored. The resulting ring can be pressed under heat during a thermal flow process into the desired seal form. As previously stated above, minor inaccuracies or score marks can be compensated for when the nozzle presses into the tool recess.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A high-stress seal for an injection molding melt delivery system including a nozzle with nozzle cap connected to a manifold through which plastic resin flows through a flow channel and a tool having an injection side portion about the nozzle and nozzle cap and an ejection side portion, the seal comprising:
an outer and inner surface area, wherein said inner surface area is shaped according to the outer surface area of the nozzle tip of the nozzle and said outer surface area is shaped according to the inner surface area of the injection side portion of the tool; and
an opening in said seal extending between the outer and inner surface areas allowing plastic resin to flow through the nozzle from the injection side portion of the tool to the ejection side portion of the tool, wherein said seal is formed to fit within a space between the nozzle tip and the injection side portion of the tool, and in which the nozzle tip and the opposing wall of the injection side portion of the tool are spatially adapted to said similarly designed seal;
wherein said seal has such a form that when placed within the space between the nozzle tip and the injection side portion of the tool, the contact pressure of the seal against the sealing surface is strengthened by the pressure of the molten plastic resin.

2. The high-stress seal according to claim 1, wherein said seal is dome-shaped having a base and a top with said opening in said top of said dome.

3. The high-stress seal according to claim 2, wherein said dome-shaped seal is conical.

4. The high-stress seal according to claim 1, wherein said seal is formed of high-temperature sealant material.

5. The high-stress seal according to claim 1, wherein said seal has such a form that when placed within the space between the nozzle tip and the injection side portion of the tool, said seal can not be measurably pushed out of place or moved from the space.

6. The high-stress seal according to claim 3, wherein said dome-shaped seal includes a hollow-cylinder seal segment extending along the base of the corresponding dome-shaped nozzle that when mounted in position, said hollow-cylinder seal segment lies between the outer wall of the nozzle tip and the nozzle cap when the nozzle cap is screwed to the nozzle.

7. The high-stress seal according to claim 6, wherein said dome-shaped seal further comprises an outwardly extending ring-shaped sealing flange which extends from said base of said dome-shaped seal that when mounted in position, said sealing flange rests between the forward face of the nozzle cap and a corresponding contact area of the injection side portion of the tool.

8. A high-stress seal for use in an injection molding melt delivery system comprising: an annular gap seal for securing a gap between two coplanar surfaces that surround a flow channel for molten plastic resin, wherein said seal is formed such that said seal seats within the space between the two opposing parts to be sealed and said seal is strengthened and cannot be measurably pushed out of place or moved from said gap when contact pressure of the molten plastic resin occurs against the sealing surface of said seal.

9. The high-stress seal according to claim 8, said seal further comprising an annular ring having an inner diameter along the flow channel for the molten plastic resin and a groove extending about said inner diameter exposed to the flow channel.

10. The high-stress seal according to claim 9, wherein said groove has a triangular profile having tapered sides converging into a rounded bottom.

11. The high-stress seal according to claim 9, wherein said annular seal ring is seated within a groove in one of the two co-planar surfaces such that the height of said seated seal in an unstressed state is greater than the depth of the co-planar surface groove.

12. The high-stress seal according to claim 11, wherein said height of said seated seal in said unstressed state is 10 percent greater than the depth of the co-planar surface groove.

13. The high-stress seal according to claim 8, wherein said seal is formed of high-temperature sealant material, including at least one of PTFE and VESPEL®.

14. The high-stress seal according to claim 8, wherein said seal can withstand pressures of up to 2500 bar.

15. The high-stress seal according to claim 8, wherein said seal is a conical dome-shaped having a base and a top with said opening in said top of said dome.

16. The high-stress seal according to claim 15, wherein said dome-shaped seal includes a hollow-cylinder seal segment extending along the base of the corresponding dome-shaped part that when mounted in position, said hollow-cylinder seal segment lies between the two opposing parts to be sealed where such opposing parts preferably are the outer wall of a nozzle tip and a nozzle cap when the nozzle cap is screwed to the nozzle.

17. The high-stress seal according to claim 16, wherein said dome-shaped seal further comprises an outwardly extending ring-shaped sealing flange which extends from said base of said dome-shaped seal that when mounted in position, said sealing flange rests between the forward face of the nozzle cap and a corresponding contact area of the injection side portion of the tool.

18. A high-stress seal for use in an injection molding melt delivery system comprising: an annular gap seal for securing a gap between two coplanar surfaces that surround a flow channel for molten plastic resin, wherein said seal is formed of high-temperature sealant material having a profile such that said seal fits within a space between the two opposing parts to be sealed and said seal is strengthened and can withstand pressures of up to 2500 bar and wherein said profiled seal cannot be measurably pushed out of place or moved from said gap when contact pressure of the molten plastic resin occurs against the sealing surface of said seal.

19. The high-stress seal according to claim 18, wherein said seal profile comprises:
an annular ring having an inner diameter along the flow channel for the molten plastic resin and a groove extending about said inner diameter exposed to the flow channel, said groove having a triangular profile including tapered sides converging into a rounded bottom, and
wherein said annular seal ring is seated within a groove in one of the two co-planar surfaces such that the height of said seated seal in an unstressed state is 10 percent greater than the depth of the co-planar surface groove.

20. The high-stress seal according to claim 18, wherein said seal profile comprises:
a conical dome-shaped seat having a base and a top with said opening in said top of said dome and includes a hollow-cylinder seal segment extending along the base of the corresponding dome-shaped part that when mounted in position, said hollow-cylinder seal segment lies between the two opposing parts to be sealed where such opposing parts preferably are the outer wall of a nozzle tip and a nozzle cap when the nozzle cap is screwed to the nozzle, and
wherein said dome-shaped seal further comprises an outwardly extending ring-shaped sealing flange which extends from said base of said dome-shaped seal that when mounted in position, said sealing flange rests between the forward face of the nozzle cap and a corresponding contact area of the injection side portion of the tool.
